(19) United States
(12) Patent Application Publication
(10) Pub. No.: US 2011/0244304 A1
(43) Pub. Date: Oct. 6, 2011

(54) STACK TYPE BATTERY

(75) Inventors: Yoshitaka Shinyashiki, Kobe-shi (JP); Hitoshi Maeda, Sumoto-shi (JP); Atsuhiro Funahashi, Osaka (JP); Masayuki Fujiwara, Kasai-shi (JP); Yuji Tani, Sumoto-shi (JP)

(73) Assignee: SANYO ELECTRIC CO., LTD., Osaka (JP)

(21) Appl. No.: 13/052,284

(22) Filed: Mar. 21, 2011

(30) Foreign Application Priority Data
Mar. 30, 2010 (JP) 2010-076862

(51) Int. Cl. H01M 2/16; H01M 2/18

(52) U.S. Cl. 429/139; 429/144

(57) ABSTRACT

A stack type battery has a plurality of positive electrode plates (1), a plurality of negative electrode plates (2), and a separator (3) interposed therebetween. The positive electrode plates (1) and the negative electrode plates (2) are alternately stacked one on the other. The separator (3) has a heat-resistant layer (3R) having heat resistance and heat-melting layers (3M), each of the heat-melting layers (3M) having a shutdown function and a melting point lower than the melting point of the heat-resistant layer (3R) and disposed over the entire surface of each of both sides of the heat-resistant layer (3R). The heat-melting layers (3M) of the separator (3) are fixed to each other by thermal welding.

### BACKGROUND OF THE INVENTION

1. Field of the Invention

The present invention relates to stack type batteries having high capacity and high-rate capability, which are used for, for example, robots, electric vehicles, and backup power sources. More particularly, the invention relates to a high-capacity lithium-ion battery that uses a separator having a multi-layered structure composed of a heat-resistant layer and a heat-melting layer to offer a high degree of safety.

2. Description of Related Art

In a stack type battery, positive electrode plates are sandwiched by a separator and the peripheral portions of the separator are thermally welded to each other so that the positive electrode plates are secured in a stacked condition. In this structure, a microporous film made of a polyolefin resin has been commonly used conventionally. This kind of separator has a problem that when heated to a high temperature of about 150° C. to 180° C. by, for example, abnormal heat generation, the separator melts or shrinks and can no longer serve the function as a separator. To improve the safety of the battery against such abnormal heat generation, a separator having heat resistance has also been used.

For example, Japanese Published Unexamined Patent Application No. 2005-183594 (Patent Document 1) discloses that heat resistance is imparted to a separator by allowing the separator to contain a heat-resistant resin having a melting point or a carbonize temperature of 300° C. or higher.

Japanese Published Unexamined Patent Application No. 2006-59717 (Patent Document 2) discloses that heat resistance is imparted to a separator by constructing the separator by a fiber assembly containing aramid fiber, polyimide fiber, and the like.

However, according to the configuration disclosed in JP 2006-59717 A (Patent Document 2), it is necessary to raise the welding temperature to approximately higher than 300° C. in order to thermally weld the separator. When the thermal welding is carried out at such a high temperature, the portion of the separator surrounding the welded part also shrinks and causes dimensional variations, resulting in misalignment of the stacked layers. In addition, the thermally fused portion of the separator may be chipped, which may become a cause of short circuits.

On the other hand, according to the configuration disclosed in JP 2005-183594 A (Patent Document 1), the welding temperature required may be less than 200° C. because the separator is thermally welded and fixed at a low-melting point portion, so the problems with JP 2006-59717 A (Patent Document 2) do not arise. However, in this configuration, the low-melting point portion is contained only partially; therefore, it does not guarantee the shutdown function for stopping the charge-discharge reactions at the time of abnormal heat generation due to, for example, overcharging.

### BRIEF SUMMARY OF THE INVENTION

Accordingly, it is an object of the present invention to provide a stack type battery that allows the separator to be thermally welded and fixed reliably without causing shrinkage or short circuiting and that can exhibit a shutdown function even at the time of abnormal heat generation so that it can offer a high degree of safety.

In order to accomplish the foregoing and other objects, the present invention provides a stack type battery comprising: a plurality of positive electrode plates; a plurality of negative electrode plates; and a separator interposed therebetween, the positive electrode plates and the negative electrode plates being alternately stacked one on the other, wherein: the separator comprises a heat-resistant layer having heat resistance and a plurality of heat-melting layers, each of the heat-melting layers having a shutdown function and a melting point lower than the melting point of the heat-resistant layer and disposed over the entire surface of each of both sides of the heat-resistant layer; and the heat-melting layers of the separator are fixed to each other by thermal welding.

In order to accomplish the foregoing and other objects, the present invention also provides a stack type battery comprising: a plurality of positive electrode plates; a plurality of negative electrode plates; and a separator interposed therebetween, the positive electrode plates and the negative electrode plates being alternately stacked one on the other, wherein: the separator comprises a heat-resistant layer having heat resistance and a heat-melting layer having a shutdown function and a melting point lower than the melting point of the heat-resistant layer and disposed over the entire surface of one side of the heat-resistant layer; and portions of the heat-melting layer of the separator are fixed to each other by thermal welding.

According to the present invention, it is possible to obtain a stack type battery that allows the separator to be thermally welded and fixed reliably without causing shrinkage or short circuiting and that can exhibit a shutdown function even at the time of abnormal heat generation so that it can offer a high degree of safety.

### BRIEF DESCRIPTION OF THE DRAWINGS

FIG. 1 is a plan view illustrating a positive electrode used for a stack type battery of the present invention;

FIG. 2 is a plan view illustrating a negative electrode plate used for the stack type battery of the present invention;

FIG. 3 is a schematic cross-sectional view illustrating a separator used for the stack type battery of the present invention;

FIG. 4 is a perspective view illustrating the separator used for the stack type battery of the present invention;

FIG. 5 is a schematic cross-sectional view illustrating how a stack unit used in the stack type battery according to the present invention is constructed and thermally welded on the whole;

FIG. 6 is a schematic partial cross-sectional view illustrating how the stack unit used in the stack type battery according to the present invention is constructed and thermally welded;

FIG. 7 is a schematic cross-sectional view illustrating a stacked electrode assembly used for the stack type battery of the present invention;

FIG. 8 is a plan view illustrating the stacked electrode assembly used for the stack type battery according to the present invention;

FIG. 9 is a plan view illustrating how current collector terminals are joined to the stacked electrode assembly used for the stack type battery according to the present invention;

FIG. 10 is a perspective view illustrating how a stacked electrode assembly is inserted in a battery case used for the stack type battery according to the present invention;

FIG. 11 is a schematic cross-sectional view illustrating how a stack unit used in the stack type battery according to another embodiment is constructed and thermally welded on the whole;

FIG. 12 is a schematic cross-sectional view illustrating a stacked electrode assembly used for the stack type battery according to another embodiment;

FIG. 13 is a plan view illustrating the stacked electrode assembly used for the stack type battery according to another embodiment;

FIG. 14 is a schematic cross-sectional view illustrating a separator used for the stack type battery according to another embodiment; and

FIG. 15 is a schematic partial cross-sectional view illustrating how a stack unit used in the stack type battery according to another embodiment is constructed and thermally welded.

### DETAILED DESCRIPTION OF THE INVENTION

A stack type battery according to the present invention may comprise: a plurality of positive electrode plates; a plurality of negative electrode plates; and a separator interposed therebetween, the positive electrode plates and the negative electrode plates being alternately stacked one on the other, wherein: the separator comprises a heat-resistant layer having heat resistance and a plurality of heat-melting layers, each of the heat-melting layers having a shutdown function and a melting point lower than the melting point of the heat-resistant layer and disposed over the entire surface of each of both sides of the heat-resistant layer; and the heat-melting layers of the separator are fixed to each other by thermal welding.

The heat-resistant layer may be one in which a substance having a melting point of 200° C. or higher, for example, a polyamide, a polyimide, or an inorganic substance such as ceramic, is adhered to its surface. The heat-melting layer may be formed of, for example, a polyolefin resin having a melting point of less than 200° C. (for example, from about 130° C. to about 170° C.) such as polyethylene and polypropylene.

In the above-described configuration of the present invention, the separator can be fixed by thermally welding the heat-melting layers with a low melting point to each other at a low welding temperature. As a result, the problems such as the misalignment of the stacked layers caused by shrinkage of the separator and the short circuiting caused by chipping of the heat-melting layer of the separator do not arise easily. Moreover, the heat-melting layer, which has a shutdown function, is disposed over the entire surface of the separator. As a result, by stopping the charge-discharge reactions by the shutdown function, battery safety can be ensured even at the time of abnormal heat generation.

In addition, by thermally welding the heat-melting layers of the separator, a pouch-type separator in which the electrode plates are enclosed so as to be sandwiched therebetween can be formed. Then, the four sides of the peripheral portions around the electrode plates can be thermally welded and fixed to each other, so it is possible to reliably prevent the contacting of the positive and negative electrodes due to the misalignment of the stacked layers.

Moreover, since the heat-melting layers are disposed on both sides, the peripheral portions of the electrode assembly in which the positive and negative electrode plates are stacked can be thermally welded to each other so as to fix the entirety of the stack unit. Therefore, the entirety of the stacked electrode assembly need not be fixed by a tape or the like, and it can be fixed reliably and easily by a simple structure.

It is desirable that: the separator be folded in a zigzag manner; the positive electrode plates and the negative electrode plates be inserted between the folds of the separator; and peripheral portions of the separator around the electrode plates be thermally welded and fixed to each other.

With the above-described configuration, it is unnecessary to cut one continuous sheet of separator having a length necessary to construct a battery into separator portions corresponding to individual layers. As a result, the manufacturing process can be made simpler correspondingly.

It is desirable that: the separator comprise separator portions separated corresponding to individual layers; the positive electrode plates and the negative electrode plates be alternately stacked one on the other with the separator portions interposed therebetween; and peripheral portions of the separator around the electrode plates be thermally welded and fixed to each other.

In the above-described configuration, the folding process as required in the case of the zigzag fold type separator is unnecessary, so the manufacturing process can be made simpler correspondingly. In addition, the folding equipment is unnecessary, so the manufacturing equipment can also be simplified.

A stack type battery according to the present invention may comprise: a plurality of positive electrode plates; a plurality of negative electrode plates; and a separator interposed therebetween, the positive electrode plates and the negative electrode plates being alternately stacked one on the other, wherein: the separator comprises a heat-resistant layer having heat resistance and a heat-melting layer having a shutdown function and a melting point lower than the melting point of the heat-resistant layer and disposed over the entire surface of one side of the heat-resistant layer; and portions of the heat-melting layer of the separator are fixed to each other by thermal welding.

In the above-described configuration of the present invention, the separator can be fixed by thermally welding the heat-melting layers with a low melting point to each other at a low welding temperature. As a result, the problems such as the misalignment of the stacked layers caused by shrinkage of separator and the short circuiting caused by chipping of the heat-melting layer of the separator do not arise easily. Moreover, the heat-melting layer, which has a shutdown function, is disposed over the entire surface of the separator. As a result, by stopping the charge-discharge reactions by the shutdown function, battery safety can be ensured even at the time of abnormal heat generation.

In addition, by thermally welding the heat-melting layers of the separator, a pouch-type separator in which the electrode plates are enclosed and sandwiched therebetween can be formed. Then, the four sides of the peripheral portions around the electrode plates can be thermally welded and fixed to each other, so it is possible to reliably prevent the contacting of the positive and negative electrodes due to the misalignment of the stacked layers.

### Description of Embodiments

Hereinbelow, with reference to the drawings, the present invention is described in further detail based on certain embodiments and examples thereof It should be construed, however, that the present invention is not limited to the following embodiments and examples, and various changes and modifications are possible without departing from the scope of the invention.

### Preparation of Positive Electrode

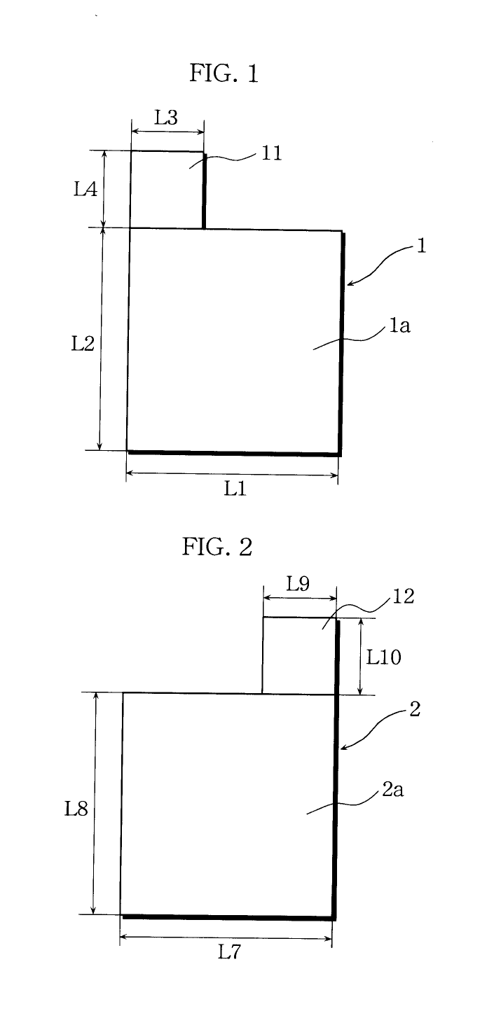

90 mass % of LiCoO₂ as a positive electrode active material, 5 mass % of carbon black as a conductive agent, and 5 mass % of polyvinylidene fluoride as a binder agent were mixed with a N-methyl-2-pyrrolidone (NMP) solution as a solvent to prepare a positive electrode mixture slurry. Thereafter, the resultant positive electrode mixture slurry was applied onto both sides of an aluminum foil (thickness: 15 μm) serving as a positive electrode current collector. Then, the material was dried to remove the solvent and compressed with rollers to a thickness of 0.1 mm. Thereafter, as illustrated in FIG. 1, it was cut into dimensions of a width L1=95 mm and a height L2=95 mm, to prepare a positive electrode plate 1 having a positive electrode active material layer la on each side thereof At this point, a positive electrode tab 11 was formed by allowing an active material uncoated portion, having a width L3=30 mm and a height L4=30 mm, to protrude from one end (the left end in FIG. 1) of one side of the positive electrode plate 1 that extends along a width L1.

### Preparation of Negative Electrode

95 mass % of graphite powder as a negative electrode active material and 5 mass % of polyvinylidene fluoride as a binder agent were mixed with an NMP solution as a solvent to prepare a negative electrode slurry. Thereafter, the resultant negative electrode slurry was applied onto both sides of a copper foil (thickness: 10 μm) serving as a negative electrode current collector. Then, the material was dried to remove the solvent and compressed with rollers to a thickness of 0.08 mm. Thereafter, as illustrated in FIG. 2, it was cut so that a width L7=100 mm and a height L8=100 mm, to prepare a negative electrode plate 2 having a negative electrode active material layer 2a on each side. At this point, a negative electrode tab 12 was formed by allowing an active material uncoated portion having a width L9=30 mm and a height L10=30 mm to protrude from one end (the right end in FIG. 2) of the negative electrode plate 2 that is opposite to the side end thereof at which the positive electrode tab 11 was formed, in one side of the negative electrode plate 2 that extends along a widthwise direction.

### Preparation of Separator

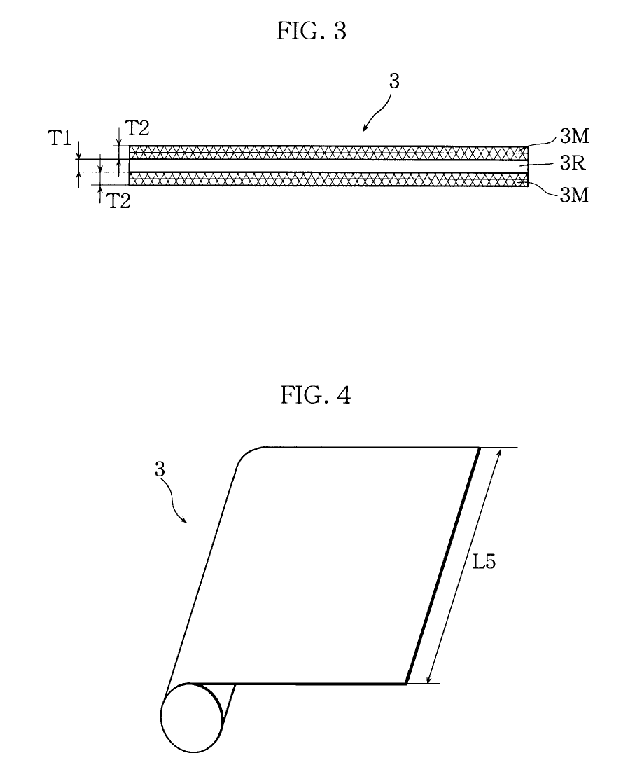

As illustrated in FIG. 3, a heat-melting layer 3M made of polyethylene (PE: melting point 130° C.) and having a thickness T2=10 nm was formed over the entire surface of each of both sides of a heat-resistant layer 3R made of an aramid resin (thermal decomposition point 500° C.) and having a thickness T1=10 nm, to form a three-layer structure having a total thickness of T1+T2+T2=30 nm. Thus, as illustrated in FIG. 4, a separator 3 having a height L5=110 mm was prepared.

### Preparation of Stacked Electrode Assembly

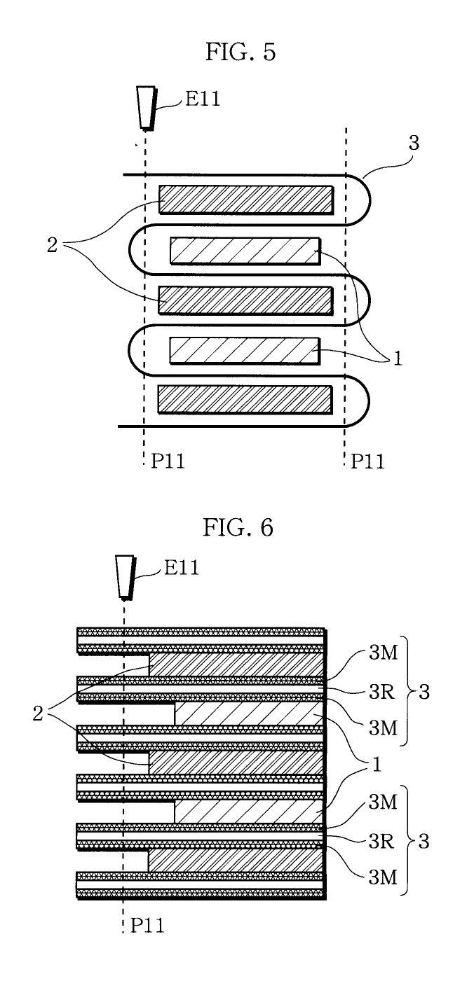

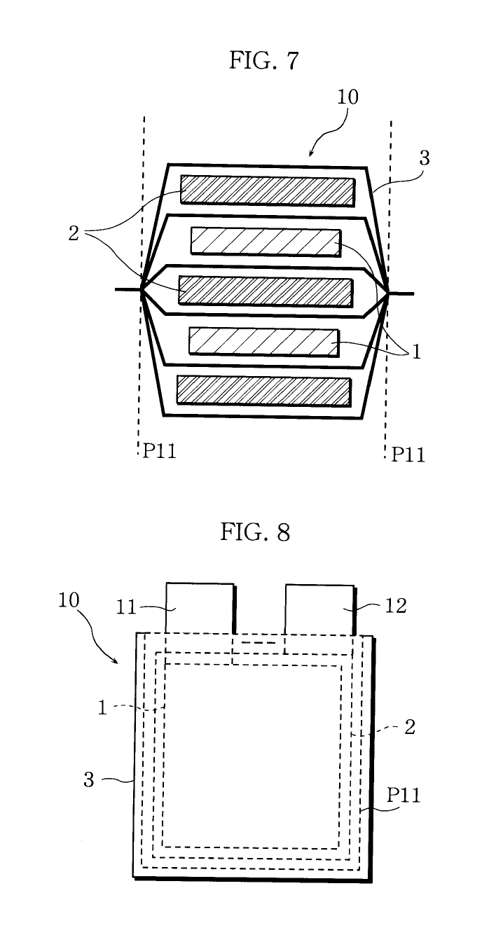

As illustrated in FIG. 5, the separator 3 was folded in a zigzag configuration, and 10 sheets of the above-described positive electrode plate 1 and 11 sheets of the above-described negative electrode plate 2 were inserted alternately therein so that the outermost faces of the stack were formed by the separator 3, to thus construct a stack unit. (Note that in FIG. 5 and the other drawings, the number of layers in the stack is shown to be less than that of the actual stack for simplification in illustration.) Subsequently, as illustrated in FIGS. 5 and 6, a metal terminal E11 heated at 200° C. was brought into contact with the separator 3 at a weld position P11 around the negative electrode plates 2 from the outermost face side, to thermally weld each layer of the separator 3 and fix the separator 3 together with the stacked positive and negative electrode plates 1 and 2. Thus, a stacked electrode assembly 10 shown in FIGS. 7 and FIG. 8 was obtained.

### Welding of Current Collector Terminals

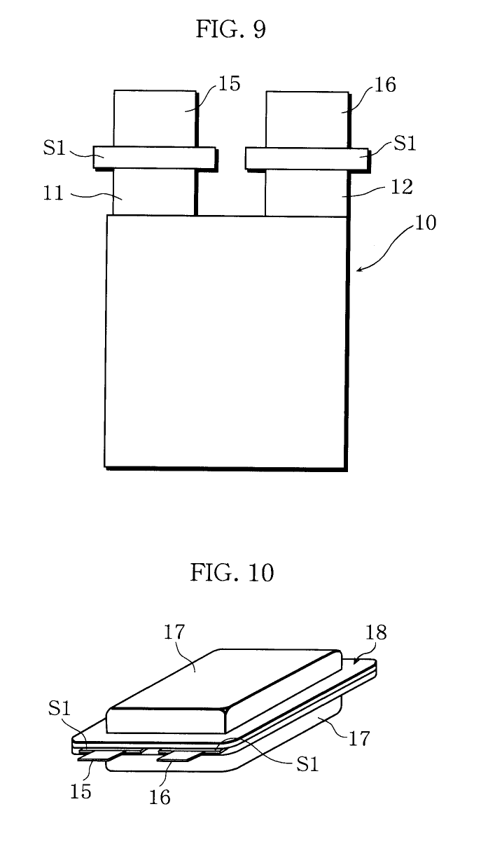

As illustrated in FIG. 9, a positive electrode current collector terminal 15 made of an aluminum plate having a width of 30 mm and a thickness of 0.5 mm and a negative electrode current collector terminal 16 made of a copper plate having a width of 30 mm and a thickness of 0.5 mm were welded respectively to the foremost ends of the positive electrode tabs 11 and the foremost ends of the negative electrode tabs 12 by ultrasonic welding.

It should be noted that reference symbol S1 in FIG. 9 and other drawings denotes a resin sealing material (adhesive material) formed so as to be firmly bonded to each of the positive and negative electrode current collector terminals 15 and 16 in a belt-like shape along a widthwise direction in order to ensure the hermeticity of a later-described battery case 18 when heat-sealing the battery case.

### Placing the Electrode Assembly in Battery Case

As illustrated in FIG. 10, the above-described stacked electrode assembly 10 was inserted into a battery case 18 formed of laminate films 17, which had been formed in advance so that the stacked electrode assembly 10 could be placed therein. Then, one side of the battery case in which the positive electrode current collector terminal 15 and the negative electrode current collector terminal 16 were present was thermally bonded so that only the positive electrode current collector terminal 15 and the negative electrode current collector terminal 16 would protrude from the battery case 18, and two sides of the remaining three sides of the battery case were thermally bonded together.

### Filling Electrolyte Solution and Sealing

An electrolyte solution was prepared by dissolving LiPF₆ at a concentration of 1 M (mol/L) in a mixed solvent of 30:70 volume ratio of ethylene carbonate (EC) and methyl ethyl carbonate (MEC). The electrolyte solution was filled into the battery case 18 from the remaining one side of the battery case that was not yet thermally bonded. Lastly, the one side that had not been thermally bonded was thermally bonded. Thus, a battery was prepared.

### EXAMPLES

### Example 1

A stack type battery fabricated in the same manner as described in the foregoing embodiment was used as the stack type battery of this example.

The battery fabricated in this manner is hereinafter referred to as Battery A1 of the invention.

In the following examples and the drawings, parts and components that are or similar to those described in the foregoing embodiment and Example 1 above as well as in FIGS. 1 through 10 are denoted by like reference numerals and symbols, and no further details thereof are given unless necessary.

### Comparative Example 1

A stack type battery was fabricated in the same manner as described for Battery A1 of the invention, except for using a separator (not shown) having a height of 110 mm and comprising a 30 μm-thick single layer structure made of polyethylene (PE).

The battery fabricated in this manner is hereinafter referred to as Comparative Battery Z1.

### Comparative Example 2

A stack type battery was fabricated in the same manner as described for Battery A1 of the invention, except for using a separator (not shown) having a height of 110 mm and comprising a 30 μm-thick single layer structure made of an aramid resin.

The battery fabricated in this manner is hereinafter referred to as Comparative Battery Z2.

Advantageous Effects obtained by Battery A1 of the Invention

The just-described battery A1 of the invention has 10 sheets of the positive electrode plate 1, 11 sheets of the negative electrode plate 2, and the separator 3 interposed therebetween. The positive electrode plates 1 and the negative electrode plates 2 are alternately stacked one on the other. The separator 3 comprises the heat-resistant layer 3R having heat resistance and the heat-melting layers 3M having a shutdown function and a melting point lower than the melting point of the heat-resistant layer 3R. The heat-melting layer 3M is disposed over the entire surface of each of both sides of the heat-resistant layer 3R. The heat-melting layers 3M of the separator 3 are fixed to each other by thermal welding.

In the above-described configuration of Battery A1 of the invention, the separator 3 is fixed by thermally welding the heat-melting layers 3M with a low melting point to each other at a low welding temperature 200° C. As a result, the problems such as the misalignment of the stacked layers caused by shrinkage of the separator 3 and the short circuiting caused by chipping of the heat-melting layers 3M of the separator 3 do not arise easily. Moreover, the heat-melting layer 3M, which has a shutdown function, is disposed over the entire surface of the separator. As a result, by stopping the charge-discharge reactions by the shutdown function, battery safety can be ensured even at the time of abnormal heat generation.

On the other hand, in the configuration of Comparative Battery Z1, the separator is constructed by a single layer structure of polyethylene (PE) having a low melting point (i.e., thermally fusible). Therefore, the shutdown function at the time of abnormal heat generation is ensured. However, when the temperature further increases to a high temperature of about 150° C. to 180° C., the separator melts or shrinks, and it can no longer serve the function required for a separator. In the configuration of Comparative Battery Z2, the separator is constructed by a single layer structure made of an aramid resin having a high melting point (i.e., heat resistance). Therefore, it does not cause the problems as in the case of Comparative Battery Z1, such as melting or shrinkage of the separator due to the high temperature at the time of abnormal heat generation. However, in order to thermally weld the separator in the manufacturing process of the battery, the separator cannot be welded together at about 200° C. as in the case of Battery A1 of the invention, and the welding temperature needs to be raised to about 600° C. When the thermal welding is carried out at such a high temperature, the portion of the separator surrounding the welded part also shrinks and causes dimensional variations, resulting in misalignment of the stacked layers. In addition, the thermally fused portion of the separator may be chipped, which may become a cause of short circuits. All these problems with Comparative Batteries Z1 and Z2 are resolved by the configuration of Battery A1 of the invention.

In the configuration of Battery A1 of the invention, by thermally welding the heat-melting layers 3M of the separator 3, the separator 3 is formed into a pouch-type structure in which the positive electrode plates 1 and the negative electrode plates 2 are enclosed. At that time, as illustrated in FIG. 8, the separator is thermally welded and fixed at the weld position P11 on the four sides around the electrode plates. As a result, it is possible to reliably prevent the contacting of the positive and negative electrodes 1 and 2 due to misalignment of the stacked layers.

Moreover, since the heat-melting layers 3M are disposed on both sides, the peripheral portions of the electrode assembly, in which the positive and negative electrode plates 1 and 2 are stacked, can be thermally welded to each other so as to fix the entirety of the stack unit. Therefore, the entirety of the stacked electrode assembly 10 need not be fixed by a tape or the like, and it is fixed reliably and easily by a simple structure.

Furthermore, the positive electrode plates 1 and the negative electrode plates 2 are inserted between the folds of the separator 3 that is folded in a zigzag manner, and the peripheral portions of the separator 3 around the electrode plates are thermally welded and fixed to each other. This eliminates the need for cutting one continuous sheet of the separator 3 having a length necessary to construct a battery into portions corresponding to individual layers. As a result, the manufacturing process is simpler correspondingly.

### Example 2

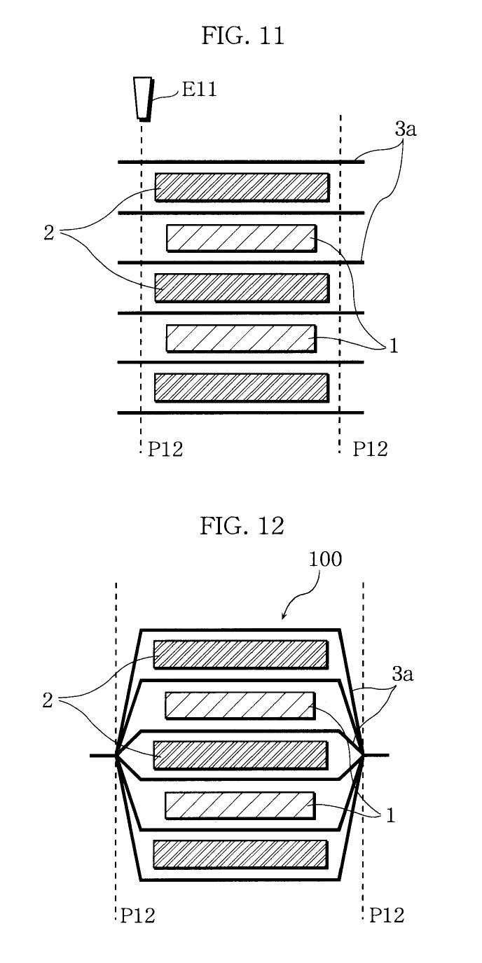

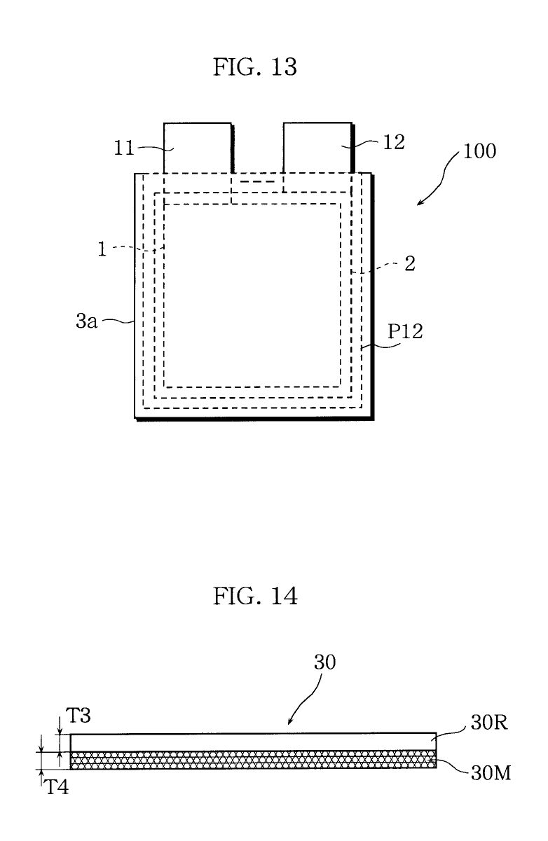

As illustrated in FIG. 11, the same separator 3 as used for the above-described Battery A1 of the invention was cut at a width of every 110 mm into 22 sheets of square-shaped separator portions 3a. In each one of the gaps between the positive and negative electrode plates 1 and 2 and on each one of the outermost faces, one sheet of the separator portion 3a was disposed so that a stack unit was constructed. Subsequently, as illustrated in the same figure, the metal terminal Ell heated at 200° C. was brought into contact with the separator portions 3a at weld positions P12 around the negative electrode plates 2 from the outermost face side, so that the separator portions 3a in the respective layers could be thermally welded and fixed together with the stacked positive and negative electrode plates 1 and 2. Thus, a stacked electrode assembly 100 shown in FIGS. 12 and FIG. 13 was obtained. A stack type battery was fabricated in the same manner as in the case of the foregoing Battery A1 of the invention, except for using the just-described stacked electrode assembly 100.

The battery fabricated in this manner is hereinafter referred to as Battery A2 of the invention.

Advantageous Effects obtained by Battery A2 of the Invention

The just-described Battery A2 of the invention exhibits basically the same advantageous effects as obtained by the previously-described Battery A1 of the invention. However, the folding process as required in the case of the zigzag fold-type separator used for Battery A1 of the invention is unnecessary and the folding equipment is accordingly unnecessary because the positive electrode plates 1 and the negative electrode plates 2 are alternately stacked one on the other with the separator portions 3a separated corresponding to individual layers and the peripheral portions of the separator portions 3a around the electrode plates are thermally welded and fixed to each other. As a result, the battery can be manufactured by simpler manufacturing equipment.

### Example 3

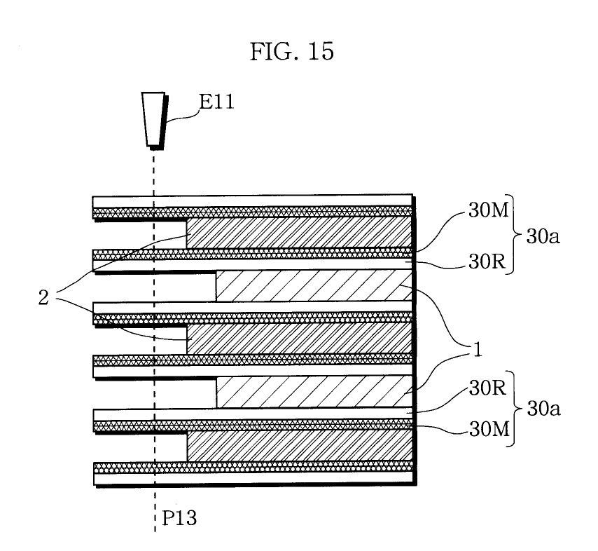

As illustrated in FIG. 14, a heat-melting layer 30M made of polyethylene (PE) and having a thickness T4=10 μm was formed over the entire surface of one side of a heat-resistant layer 30R made of an aramid resin and having a thickness T3=10 μm, to form a two-layer structure having a total thickness of T3+T4=20 μm. Thus, a separator 30 having a height of 110 mm was prepared. Next, the separator 30 was cut at a width of every 110 mm into 22 sheets of square-shaped separator portions 30a. Then, as illustrated in FIG. 15, in each one of the gaps between the positive and negative electrode plates 1 and 2 and on each one of the outermost faces, one sheet of the just-described separator portion 30a was disposed, whereby a stack unit was constructed. Subsequently, as illustrated in the same figure, the metal terminal E11 heated at 200° C. was brought into contact with the separator portions 30a at weld positions P13 around the negative electrode plates 2 from the outermost face side, to thermally weld the opposing heat-melting layers 30M of the separator portions 30a to each other so that the negative electrode plates 2 therebetween were fixed while they were being sandwiched by the separator portions 30a from both sides. Thereafter, the entirety of the stack unit was fixed with a tape. Thereby, a stacked electrode assembly was obtained. A stack type battery was fabricated in the same manner as in the case of the foregoing Battery A1 of the invention, except for using the just-described stacked electrode assembly.

The battery fabricated in this manner is hereinafter referred to as Battery A3 of the invention.

Advantageous Effects obtained by Battery A3 of the Invention

The just-described battery A3 of the invention has 10 sheets of the positive electrode plate 1 and 11 sheets of the negative electrode plate 2, which are alternately stacked one on the other with the separators 30 interposed therebetween. The separator 30 comprises the heat-resistant layer 30R having heat resistance and the heat-melting layer 30M having a shutdown function and a melting point lower than the melting point of the heat-resistant layer 30R. The heat-melting layer 30M is disposed over the entire surface of one side of the heat-resistant layer 30R. The heat-melting layers 30M of the separator 30 are fixed to each other by thermal welding.

In the above-described configuration of Battery A3 the invention, the separator 30 is fixed by thermally welding the heat-melting layers 30M with a low melting point to each other at a low welding temperature 200° C. As a result, the problems such as the misalignment of the stacked layers caused by shrinkage of the separator 30 and the short circuiting caused by chipping of the heat-melting layers 30M of the separator 30 do not arise easily. Moreover, the heat-melting layer 30M, which has a shutdown function, is disposed over the entire surface of the separator. As a result, by stopping the charge-discharge reactions by the shutdown function, battery safety can be ensured even at the time of abnormal heat generation.

Moreover, by thermally welding the heat-melting layers 30M of the separator 30 to each other, the separator 30 is formed into a pouch-type structure in which the negative electrode plates 2 are enclosed so as to be sandwiched. At that time, the separator is thermally welded and fixed at the weld position P13 on the four sides around the electrode plates. As a result, it is possible to reliably prevent the contacting of the positive and negative electrodes 1 and 2 due to the misalignment of the stacked layers.

### Other Embodiments

(1) The positive electrode active material is not limited to lithium cobalt oxide.

Other usable materials include lithium composite oxides containing cobalt, nickel, or manganese, such as lithium cobalt-nickel-manganese composite oxide, lithium aluminum-nickel-manganese composite oxide, and lithium aluminum-nickel-cobalt composite oxide, as well as spinel-type lithium manganese oxides.
(2) Other than the graphite such as natural graphite and artificial graphite, various materials may be employed as the negative electrode active material as long as the material is capable of intercalating and deintercalating lithium ions. Examples include coke, tin oxides, metallic lithium, silicon, and mixtures thereof
(3) The electrolyte is not limited to that shown in the examples above, and various other substances may be used. Examples of the lithium salt include LiBF₄, LiPF₆, LiN(SO₂CF₃)₂, LiN(SO₂C₂F₅)₂, and LiPF₆₋ₓ(CₙF₂ₙ₊₁)ₓ (where 1<x<6 and n=1 or 2), which may be used either alone or in combination. The concentration of the supporting salt is not particularly limited, but it is preferable that the concentration be restricted in the range of from 0.8 moles to 1.8 moles per 1 liter of the electrolyte solution. The types of the solvents are not particularly limited to EC and MEC mentioned above.

Examples of preferable solvents include carbonate solvents such as propylene carbonate (PC), γ-butyrolactone (GBL), ethyl methyl carbonate (EMC), dimethyl carbonate (DMC), and diethyl carbonate (DEC). More preferable is a combination of a cyclic carbonate and a chain carbonate.

The present invention is suitably applied to, for example, power sources for high-power applications, such as backup power sources and power sources for the motive power incorporated in robots and electric automobiles.

While detailed embodiments have been used to illustrate the present invention, to those skilled in the art, however, it will be apparent from the foregoing disclosure that various changes and modifications can be made therein without departing from the spirit and scope of the invention. Furthermore, the foregoing description of the embodiments according to the present invention is provided for illustration only, and is not intended to limit the invention.

What is claimed is:

1. A stack type battery comprising: a plurality of positive electrode plates; a plurality of negative electrode plates; and a separator interposed therebetween, the positive electrode plates and the negative electrode plates being alternately stacked one on the other, wherein: the separator comprises a heat-resistant layer having heat resistance and a plurality of heat-melting layers, each of the heat-melting layers having a shutdown function and a melting point lower than the melting point of the heat-resistant layer and disposed over the entire surface of each of both sides of the heat-resistant layer; and the heat-melting layers of the separator are fixed to each other by thermal welding.

2. The stack type battery according to claim 1, wherein the separator is folded in a zigzag manner; the positive electrode plates and the negative electrode plates are inserted between the folds of the separator; and peripheral portions of the separator around the electrode plates are thermally welded and fixed to each other.

3. The stack type battery according to claim 1, wherein the separator comprises separator portions separated corresponding to individual layers; the positive electrode plates and the negative electrode plates are alternately stacked one on the other with the separator portions interposed therebetween; and peripheral portions of the separator around the electrode plates are thermally welded and fixed to each other.

4. A stack type battery comprising: a plurality of positive electrode plates; a plurality of negative electrode plates; and a separator interposed therebetween, the positive electrode plates and the negative electrode plates being alternately stacked one on the other, wherein: the separator comprises a heat-resistant layer having heat resistance and a heat-melting layer having a shutdown function and a melting point lower than the melting point of the heat-resistant layer and disposed over the entire surface of one side of the heat-resistant layer; and portions of the heat-melting layer of the separator are fixed to each other by thermal welding.
